(19) United States
(12) Patent Application Publication
(10) Pub. No.: US 2006/0201545 A1
(43) Pub. Date: Sep. 14, 2006

(54) Fire resistant laminate and photovoltaic module incorporating the fire resistant laminate

(76) Inventors: Stanford R. Ovshinsky, Bloomfield Hills, MI (US); Lin R. Higley, Troy, MI (US); Marshall D. Muller, Farmington, MI (US); Timothy Ellison, Holly, MI (US); Joachim Doehler, White Lake, MI (US); Buddie R. Dotter II, Shelby Twp, MI (US); Steve Heckeroth, Albion, CA (US)

Correspondence Address: ENERGY CONVERSION DEVICES, INC., 2956 WATERVIEW DRIVE, ROCHESTER HILLS, MI, 48309, US

(21) Appl. No.: 11/356,376

(22) Filed: Feb. 16, 2006

Related U.S. Application Data
(60) Provisional application No. 60/653,441, filed on Feb. 16, 2005.

(51) Int. Cl. H02N 6/00

(52) U.S. Cl. 136/251

(57) ABSTRACT

The present invention discloses a fire resistant laminate and incorporating the laminate into an encapsulant for a photovoltaic module that may be used in a photovoltaic building material. More particularly, the present invention relates to fire resistant encapsulant that may be used in a triple junction amorphous silicon photovoltaic module that is fire resistant on a wide variety of buildings roofs, including residential housing, and that is flexible and lightweight. A fire resistant additive, such as solid glass spheres, may be added to encapsulant material to produce a fire resistant, cut resistant, lightweight photovoltaic device.

### RELATED APPLICATION INFORMATION

This application claims the benefit of U.S. Provisional Application Ser. No. 60/653,441, entitled Fire Resistant Laminate and Photovoltaic Module Incorporating the Fire Resistant Laminate, filed Feb. 16, 2005, the disclosure of which is herein incorporated by reference.

### FIELD OF THE INVENTION

The present invention relates to a fire resistant laminate and incorporating the laminate into an encapsulant for a photovoltaic module that may be used in a photovoltaic building material. More particularly, the present invention relates to fire resistant encapsulant that may be used in a triple junction amorphous silicon photovoltaic module that is fire resistant on a wide variety of buildings roofs, including residential housing, and that is flexible and lightweight.

### BACKGROUND OF THE INVENTION

Photovoltaic energy is becoming a very significant source of electrical power. This is because problems of scarcity and safety have limited the use of fossil and nuclear fuels, and recent advances in photovoltaic technology have made possible the large scale manufacture of low cost, lightweight, thin film photo voltaic devices. It is now possible to manufacture large scale, thin film silicon and/or germanium alloy materials which manifest electrical and optical properties equivalent, and in many instances superior to, their single crystal counterparts. These alloys can be economically deposited at high speed over relatively large areas and in a variety of device configurations, and as such they readily lend themselves to the manufacture of low cost, large area photovoltaic devices. U.S. Pat. Nos. 4,226,898 and 4,217,364 both disclose particular thin film alloys having utility in the manufacture of photovoltaic devices of the type which may be employed in the present invention. However, it is to be understood that the present invention is not limited to any particular class of photovoltaic materials and may be practiced with a variety of semiconductor materials including amorphous, crystalline, polycrystalline, microcrystalline, and noncrystalline materials.

In addition to being heavy, prior art devices tend to be rigid, and this rigidity, together with weight, complicates shipping, handling and installation. Further problems of installation occur when photovoltaic devices are mounted, since mounting typically requires use of special frames and/or fasteners such as nails and screws which penetrate the photovoltaic device or mounting structure. The use of penetrating fasteners is complicated by the fact that such fasteners should not penetrate the photovoltaically active portions of a roofing material. Therefore, complex mounting hardware is frequently required to assure that photovoltaic devices are retained on a building structure with sufficient integrity to resist storm conditions. The prior art has implemented a number of approaches to the fabrication of photovoltaic roofing materials. For example, U.S. Pat. Nos. 5,092,939; 5,232,518 and 4,189,881 disclose photovoltaic roofing structures of the batten and seam type. U.S. Pat. No. 4,860,509 discloses roll type roofing material having photovoltaic devices incorporated therein. U.S. Pat. Nos. 5,575,861 and 5,437,735 disclose photovoltaic shingles.

Photovoltaic building materials frequently include polymeric encapsulant, asphalt based sealers, fibrous support materials and the like, all of which can be flammable, particularly given the fact that such materials are usually used in the form of relatively thin sheets. Building codes generally set flammability standards for construction materials. Such standards specify the rate at which flame will spread across a material. When relatively flammable materials are incorporated into building structures, insurance rates for the buildings may be increased to the point that construction is prohibitive. Also, in many cases, building codes are strict enough to preclude the use of flammable materials. Further, the frequency of wild fires, particularly in the western United States, demands that construction materials used for building structures, such as residential housing, maximize fire resistance.

In addition to fire resistance, cut resistance is very important when high voltage solar systems are used. High voltage solar systems must pass dielectric breakdown tests at least 2× the system voltage. This test is performed with over an 8-pound load used during the scratch test, and with the higher the better. When systems get over 900 V, an 8 lb test will be inadequate.

Currently there exists a need in the art for a photovoltaic module that is light weight, sufficiently transparent to UV rays, flexible enough to be installed over irregular surfaces, cut resistant and sufficiently fire resistant on a wide variety of roofs, including residential housing. The present invention overcomes deficiencies in the prior art by combining an additive to encapsulant material to provide a laminate for use in a photovoltaic module that is light weight, flexible and fire resistant.

### SUMMARY OF THE INVENTION

Embodiments of the present invention disclosed a laminate and an encapsulant for use in a photovoltaic building material which preferably comprises a generally planar, flexible substrate having a first and a second opposed side. A photovoltaic device, operative to generate a current in response to the absorption of incident light, is supported on the substrate so that the bottom side of the photovoltaic device faces the first side of the substrate and the top, light incident, side of the photovoltaic device faces away from the substrate and toward a light source. An encapsulant material with additive covers the light incident side of the photovoltaic device and may also affix that device to the substrate. At least that portion of the encapsulant material with additive which covers the light incident side of the photovoltaic device is sufficiently light transmissive to enable operation of the photovoltaic device. Preferably, the building material of the present invention is flexible, lightweight and fire resistant.

An embodiment of the present invention provides a fire resistant laminate. The fire resistant laminate comprises an adhesive material having a fire resistant additive, such as glass spheres or other solid phase material dispersed therein. The adhesive material may be selected from polymers, particularly fluoropolymers, ethylenevinylacetate (EVA), silicon, urethane, a sodium ionomer or a zinc ionomer.

An embodiment of the present invention provides a flexible photovoltaic module that is cut resistant and fire resistant while reducing manufacturing cost. Portions of the laminate of a photovoltaic module are replaced by non-flammable inert material that maintains sufficient transparency to enable operation of the photovoltaic device and provides sufficient cut resistance.

Embodiments of the present invention provide a fire resistant photovoltaic module comprising a photovoltaic cell having a light incident side and a substrate side. A substrate is adhered to the substrate side of the photovoltaic cell and an encapsulant layer covering the light side of said photovoltaic cell. Further, the encapsulant layer preferably comprises a fire resistant laminate. The fire resistant laminate may comprise an encapsulant material having at least one fire resistant additive. The encapsulant material may include ethylenevinylacetate (EVA), silicon, urethane, a sodium ionomer or a zinc ionomer.

Embodiments of the present invention provide a photovoltaic building material comprising a generally planar, flexible substrate having a first side and a second side opposed to said first side and a photovoltaic device operative to generate an electrical current in response to the absorption of light incident thereupon. The photovoltaic device is adhered to the substrate, wherein the bottom side of the device faces the first side of the substrate and the top, light incident side of the device faces away from substrate. Further, an encapsulant layer disposed to cover the light incident side of said photovoltaic device, at least a portion of the encapsulant material which covers the light incident side of the photovoltaic device having sufficient light transmissivity. The encapsulant layer comprises an encapsulant layer having at least one fire resistant additive, such as a dispersed solid phase material, preferably solid glass spheres.

Embodiments of the present invention provide a fire resistant and cut resistant encapsulant layer for use in a photovoltaic module. In a preferred embodiment clear glass micro spheres are mixed into the adhesive layer of a photovoltaic cell with a 20% to 95% by volume addition. The composite of glass, both fiber and spheres, with an appropriate adhesive replaces or adds to the existing glass fiber adhesive layer mixture. This transparent multiple function layer is toughened by the composite nature of the combination with the addition of the spheres. The resistance to scratching of this instant invention exceeds the required post dielectric breakdown requirement of twice the solar panel voltage and will allow the safe operation of high voltage arrays. The fire resistance and cost is greatly improved by the replacement of the flammable and costly organic adhesives with the space filling inert glass spheres held together by the same organic adhesive.

Preferably, the encapsulant layer of the photovoltaic module comprises an encapsulant material with additive that is more fire resistant than the encapsulant material alone. One such additive is glass spheres. Preferably, the glass spheres are constructed to avoid interference with the index of refraction, therefore solid glass spheres are preferred over hollow glass spheres. Glass spheres may be added to an encapsulant material. The encapsulant material is any material that is sufficiently transparent to allow a light source, such as sunlight, to contact the light incident side of the photovoltaic device. The encapsulant material may also act as an adhesive to maintain the integrity of the photovoltaic module. Preferred encapsulant materials include polymers, including fluoropolymers, silicon, urethane and light transmitting ionomers, particularly zinc-based ionomers and sodium-based ionomers. The additive may be a combination of glass spheres and glass fibers.

An embodiment of the present invention discloses a fire resistant photovoltaic module comprising a photovoltaic cell having a light incident side and a substrate side, wherein the substrate side is adhered to a substrate. Further, a fire resistant encapsulant layer covers the light side of the photovoltaic cell, wherein the fire resistant encapsulant comprises an encapsulant having a fire resistant additive. The additive may be solid glass spheres having a diameter of about 80 μm to about 250 μm.

### BRIEF DESCRIPTION OF THE DRAWINGS

In order to assist in the understanding of the various aspects of the present invention and various embodiments thereof, reference is now made to the appended drawings, in which like reference numerals refer to like elements. The drawings are exemplary only, and should not be construed as limiting the invention.

FIG. 1 is a fragmentary, cross-sectional view of a tandem or cascade photovoltaic device comprising a plurality of p-i-n-type cells;

FIG. 2a is a cross-sectional view of an embodiment of the fire resistant photovoltaic module of the present invention wherein the photovoltaic module comprises an encapsulant material having glass spheres interspersed throughout the encapsulant material layered on the light incident side of the photovoltaic device and a layer of encapsulant material between the photovoltaic device and the substrate;

FIG. 2b is a cross-sectional view of an embodiment of the fire resistant photovoltaic module of the present invention wherein the photovoltaic module comprises an encapsulant material having glass spheres interspersed throughout the encapsulant material encapsulating the photovoltaic device and adhered to the substrate;

FIG. 3 is a cross-sectional view of an embodiment of the fire resistant photovoltaic module of the present invention wherein the photovoltaic module comprises an encapsulant material having glass spheres interspersed throughout the encapsulant material layered on the light incident side of the photovoltaic device and the photovoltaic device directly on the substrate;

FIG. 4 is a cross-sectional view of an embodiment of the fire resistant photovoltaic module of the present invention wherein the photovoltaic module comprises an encapsulant material having glass spheres interspersed throughout the encapsulant material wherein the encapsulant material wraps around the photovoltaic device and the substrate.

FIG. 5 depicts flame spread test results for selected photovoltaic modules according to the instant invention; and

FIG. 6 depicts cut resistance test results for selected photovoltaic modules according to the instant invention.

### DETAILED DESCRIPTION OF EMBODIMENTS OF THE INVENTION

The present invention is directed to a fire resistant laminate for a photovoltaic module that may be used as a photovoltaic building material. It is to be understood that, in the context of this disclosure, a building material refers to a generally weather resistant structural material having sufficient integrity to use as a primary or supplementary covering for a portion of a building structure, and as such includes material adapted to be disposed upon a roof of a building, as well as sheathing material configured to be disposed onto an exterior surface of a building. The replacement of encapsulant material, such as EVA adhesive, with inert glass spheres produces a fire resistant, flexible, scratch resistant photovoltaic module.

Embodiments of the encapsulant layer of the photovoltaic module comprise an encapsulant material with additive that is more fire resistant than the encapsulant material alone. One such additive is glass spheres. Preferably, the glass spheres are constructed to avoid interference with the index of refraction, therefore solid glass spheres are preferred over hollow glass spheres.

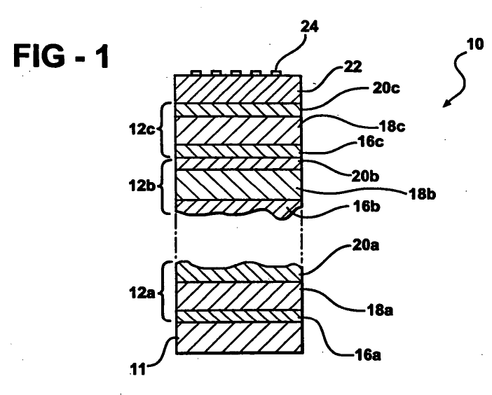

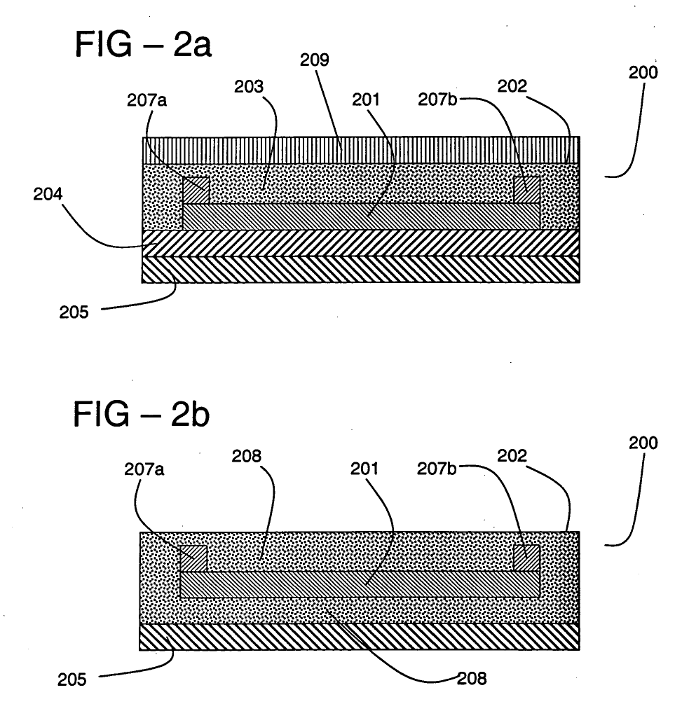

Referring to FIG. 2a, an embodiment of the fire resistant encapsulant/laminate of the present invention is illustrated as part of a photovoltaic module, generally referred to as 200. An embodiment of the encapsulant of the present invention is shown affixed to the upper, transparent conductive electrode of a photovoltaic cell 201 producing a photovoltaic module 200, the photovoltaic cell 201 generally similar to that shown in FIG. 1. A first encapsulant layer 202 may be disposed over the photovoltaic cell 201 and bus bars 207a and 207b, the first encapsulant layer comprising an encapsulant material having a fire resistant additive 203. The first encapsulant layer 202 may include a plurality of layers in a superposed relationship to the photovoltaic cell, at least one of which is the fire resistant encapsulant of the present invention. The body of a photovoltaic device 201 is supported by a substrate material 205. The photovoltaic device may be retained on the substrate by the first encapsulant layer 202. A second encapsulant layer 204 may be disposed between the photovoltaic device 201 and the substrate 205. The second encapsulant layer may include the encapsulant of the present invention, however, the first and second encapsulant layers 202 and 204 may be the same or different. FIG. 2b illustrates the embodiment wherein a single encapsulant layer 202 entirely encapsulates the photovoltaic device 201 and bus bars 207a and 207b and is supported by the substrate 205.

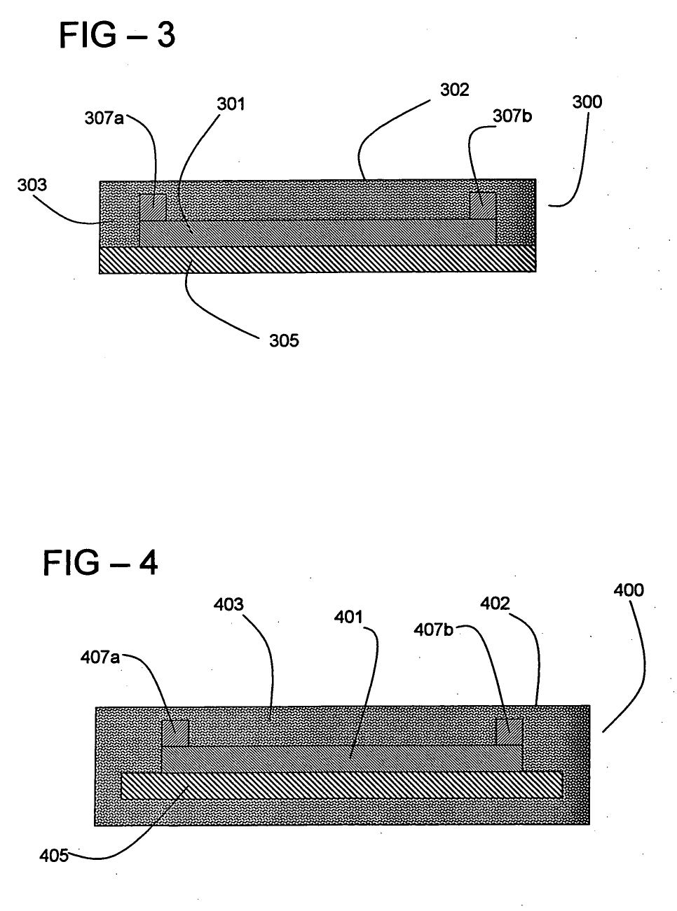

Referring to FIG. 3, an embodiment of the fire resistant encapsulant/laminate of the present invention is illustrated as part of a photovoltaic module, generally referred to as 300. An embodiment of the encapsulant of the present invention is shown affixed to the upper, transparent conductive electrode of a photovoltaic cell 301 producing a photovoltaic module 300, the photovoltaic cell 201 generally similar to that shown in FIG. 1. An encapsulant layer 302 may be disposed over the photovoltaic cell 301 and bus bars 307a and 307b, the encapsulant layer comprising an encapsulant material having a fire resistant additive 303. The encapsulant layer 302 may include a plurality of layers in a superposed relationship to the photovoltaic cell, at least one of which is the fire resistant encapsulant of the present invention. The body of a photovoltaic device 201 is supported by a substrate material 305. The photovoltaic device may be retained on the substrate by the first encapsulant layer 302. Referring to FIG. 4, an embodiment of the fire resistant encapsulant/laminate of the present invention is illustrated as part of a photovoltaic module, generally referred to as 400. An encapsulant 402 of the present invention encapsulates the photovoltaic cell 401, bus bars 407a and 407b and substrate 405.

A preferred embodiment of the encapsulant/laminate of the present invention comprises a suitable amount of a solid phase material interspersed into an encapsulant/laminate material to reduce flammability while maintaining acceptable transmissivity. In one embodiment, the interspersed solid phase material comprises glass, where the glass is in the form of pieces, particles, fibers, spheres, or a combination thereof. Preferably, the interspersed solid phase material is present in an amount wherein the light transmission of the outer layer is greater than 60% at a wavelength greater than 300 nm. Preferably, the interspersed solid phase material is dispersed within the encapsulant material to produce a 1:1 ratio with respect to volume. In a photovoltaic module of the present invention, the total thickness of the encapsulant layer is chosen to maintain flexibility, scratch resistance and fire resistance. The thickness of the encapsulant layer in some prior art photovoltaic modules is controlled by pressure and the glass mat (e.g. GMC) thickness and density. The thickness of the encapsulant layer may be controlled through the size of the pieces of the interspersed solid phase material and the amount of solid phase material. A few larger pieces of solid phase material in the mix can set the thickness, where smaller solid phase pieces glass spheres content and size ratio will set the loading adhesive fraction. This control of thickness that is dictated by the larger solid phase pieces may allow for elimination the glass mat and its cost in the construction of a photovoltaic module.

In one embodiment, the solid phase pieces are glass spheres. The glass spheres preferably have a diameter of about 80 μm to about 250 μm. More preferably the spheres interspersed throughout the encapsulant are a mixture of sizes to allow the smaller spheres to fill the interstitial spaces between the larger spheres. A certain percentage of spheres, fibers, chips or pieces are acceptable, depending on the application. For example, in relation to a photovoltaic module, a sufficient amount of chips/pieces etc. may cause light trapping that decreases transparency and thus the efficiency of the photovoltaic device. Preferably, chips/pieces account for no more than 4% of the glass spheres in the encapsulant material.

Preferably the spheres are nonporous, so the spheres do not absorb resin in a polymer system. Before mixing with the encapsulant material, the spheres are preferably heated to reduce moisture and air on the surface of the spheres that may interfere with the bonding. The preferred method of reducing moisture and air is baking in an oven.

Examples of glass spheres suitable for use in the present invention are sold by Potters Industries, Inc and sold under the name SPHERIGLASS®, which are solid white microspheres with a density of 2.5 g/cc. The spheres are very strong, with a crush strength in excess of 30,000 psi. SPHERIGLASS(® spheres are available in two glass compositions: A-glass (soda-lime glass) and E-glass (borosilicate glass). In most thermoset and thermoplastic resin systems, A-glass is satisfactory. E-glass is recommended for use with polycarbonate, acetal, and PTFE systems or other alkalisensitive resins.

It should be apparent from the detailed description and the embodiments disclosed that the embodiments of the fire resistant photovoltaic material described herein are examples of the present invention and should not be considered limited to the devices described. It is understood that the photovoltaic modules described are for illustration and should not be considered limiting and the encapsulant of the present invention may be used in any photovoltaic device that requires the characteristics described. Further, the encapsulant of the present invention may be utilized in any device that requires the characteristics described. Also, it is to be understood that the thicknesses of various of the layers may be exaggerated for purposes of illustration.

In one preferred embodiment, the substrate is at least 50, and typically 100 times thicker than any of the overlying individual semiconductor or electrode layers of the device. The substrate is a generally self supporting member typically fabricated from sheet metal having a thickness of at least 1 mil. In contrast, the overlying layers have a total thickness which is usually no more than several microns; although for clarity of illustration, the thickness of the layers has been exaggerated in the Figures. While the substrate has no upper limit on thickness, in the interest of material economy, ease of handling and maintenance of flexibility, it will most generally be preferred that the substrate be less than 1 millimeter in thickness and most preferably have a thickness in the range of 3-10 mils. The substrate may be fabricated from any electrically conductive metal and is most preferably fabricated from stainless steel, brass, copper, aluminum, kevlar or any other such low cost metal or plastic having acceptable electrical conductivity. In some instances, the substrate may further include a backing or support layer and all such substrates are encompassed within the definition of monolithic substrates in accord with the present disclosure.

The encapsulant material is preferably electrically insulating, and resistant to ambient atmospheric conditions (such as UV exposure, moisture or humidity). Among the preferred encapsulant materials are polymers, including fluoropolymers, silicon, urethane and light transmitting ionomers, particularly zinc-based ionomers and sodium-based ionomers. Other encapsulant materials having utility in the present invention are disclosed in U.S. Pat. No. 5,474,620 issued to Nath et al. on Dec. 15, 1995, the disclosure of which is hereby incorporated herein by reference. As illustrated in FIG. 2b, the encapsulant layer 202 encapsulates the photovoltaic device 201 and bus bars 207a and 207b, covers the bottom surface of the photovoltaic device 201, adheres the photovoltaic device 201 to the substrate 205, and covers the remainder of the photovoltaic device 201. Preferably, the encapsulant layer 202 is a fire resistant encapsulant comprising an encapsulant material interspersed with glass spheres 208. At least those portions of the encapsulant 202 which cover the light incident side of the photovoltaic device 201 should be sufficiently light transmissive. The encapsulant material may include ethylenevinylacetate (EVA), silicon, urethane, a sodium ionomer or a zinc ionomer.

Examples of zinc-based ionomers are sold under the trademark name SURLYN®, produced by Du Pont Co. These polymers have excellent optical properties and high hot tack strength. The material may be produced by adding a salt containing zinc cations to a copolymer of ethylene-methacrylic acid, or to a copolymer of ethylene-acrylic acid, and subjecting that composition to acid neutralization, resulting in the formation of ion clusters within the resulting polymer matrix.

In a preferred embodiment, illustrated in FIG. 2a, a surface side covering 209 may be adhered to the encapsulant material 203. In order to improve moisture resistance and scratch resistance, a fluorine type resin may be superposed as a surface side covering 209. The surface side covering material 209 may comprise an appropriate fluororesin. Such fluororesin can include, for example, ethylene-tetrafluoroethylene copolymer (ETFE), such as the one sold under the trademark name TEFZEL®, produced by Du Pont Company; copolymer of TFE (tetrafluoroethylene), such as the one sold under the name TEFLON®, produced by Du Pont Company; polyvinyl fluoride (PVF), such as the one sold under the trademark name TEDLAR®, produced by Du Pont Company; and chlorotrifluoroethylene (CTFE), such as the one sold under the trademark name NEOFRON®, produced by Daikin Kohgyo Kabushiki Kaisha. These resins may contain a conventional UV absorber in order to improve their weatherability.

Referring now to the drawings and particularly to FIG. 1, there is depicted generally, by the reference numeral 10, a photovoltaic cell formed of at least one triad of successively deposited layers of p-i-n semiconductive material, each layer of which is in turn formed of, preferably, a thin film semiconductor alloy material. This device is representative of those which may be advantageously employed in combination with the present invention.

More particularly, FIG. 1 illustrates a p-i-n type photovoltaic device, such as a solar cell made up of individual p-i-n type cells 12a, 12b and 12c. Below the lowermost cell 12a is a substrate 11 which may be transparent or may be formed from a metallic material such as stainless steel, aluminum, tantalum, molybdenum, chrome, or metallic particles embedded within an insulator (cermets). However, most preferred substrates do not restrict flexibility of the photovoltaic building material. Although certain applications may require a thin oxide layer and/or a series of base contacts prior to the deposition of the amorphous semiconductor alloy material, for purposes of the instant application, the term “substrate” shall include not only a flexible film, but also any elements added thereto by preliminary processing.

Each of the cells 12a, 12b, and 12c are preferably fabricated from a body of thin film semiconductor alloy material containing at least silicon and hydrogen. Each of the bodies of semiconductor alloy material includes an n-type layer of semiconductor alloy material 20a, 20b, and 20c; a substantially intrinsic layer of semiconductor alloy material 18a, 18b, and 18c; and a p-type layer of semiconductor alloy material 16a, 16b, and 16c. Note that the intrinsic layer may include traces of n-type or p-type dopant material without forfeiting its characteristic neutrality; hence it may be referred to as a “substantially intrinsic layer”. It is worth noting that the layers of intrinsic semiconductor alloy material 18a, 18b, and 18c of the photovoltaic cells 12a, 12b, and 12c may be formed from semiconductor alloys of silicon having different band gaps tailored to photogenerate charge carriers in response to different wavelengths of light of the incident solar spectrum. For example, intrinsic layer 18c may have an optical band gap of approximately 1.7 electron volts (eV); intrinsic layer 18b may have a band gap of approximately 1.5 Ev; and intrinsic layer 18a may have a band gap of approximately 1.3 eV. Finally, as illustrated, solar cell 12b is an intermediate cell and as indicated in FIG. 1, additional intermediate solar cells may be stacked atop the illustrated cells without departing from the spirit or scope of the instant invention.

Also, although p-i-n type photovoltaic cells are depicted, the methods and materials of this invention may also be used to produce single or multiple n-i-p type solar cells, p-n type cells or devices, Schottky barrier devices, as well as other semiconductor elements and/or devices such as diodes, memory arrays, photoresistors, photodetectors, transistors, etc. The term “p-i-n type”, as used herein, is defined to include any aggregation of n, i, and p layers operatively disposed to provide a photoresponsive region for generating charge carriers in response to absorption of photons.

It should also be noted that while the present invention is preferably a tandem devices comprised of stacked N-I-P type cells as described in U.S. Pat. No. 5,977,476 issued to Guha et al. on Nov. 2, 1999 and hereby incorporated herein by reference, the present invention may also be advantageously practiced in connection with devices comprised of single N-I-P type cells, since in general, the high electrical conductivity and the optical transparency of the microcrystalline N layer will benefit single cells as well as tandem devices.

The photovoltaic building material of the present invention includes a body of substrate material which supports the remaining layers thereof. The substrate material is preferably a conventional roofing material such as metal foil, stainless steel, a polymeric membrane, or a body of fibrous material such as woven or nonwoven cloth, paper and the like impregnated with a polymeric material such as asphalt, tar or synthetic polymers. The substrate material is preferably flexible and lightweight, and should be water resistant. The photovoltaic device is supported on a first surface of the substrate material. Also included within the scope of the invention are substrates formed of glass or a glass-like material such as a synthetic polymeric resin on which an electrically conductive electrode is secured, although these substrates typically decrease flexibility and increase weight.

The photovoltaic module device may be any photovoltaic device known in the art. Most preferably, the photovoltaic device is flexible and lightweight. Photovoltaic devices fabricated from thin film semiconductor material such as silicon, germanium, and silicon-germanium alloyed with hydrogen and/or halogens and/or dopant materials may be employed with particular advantage to fabricate lightweight, thin film photovoltaic devices having good efficiencies and long service lives, and such materials are employed in one particularly preferred embodiment of the present invention. Other preferred thin film materials include copper indium diselenide, cadmium sulfide and the like.

The principles of the present invention may be advantageously practiced in connection with other photovoltaic devices such as crystalline silicon devices, polycrystalline silicon devices, and the like. As illustrated in FIGS. 2a and 2b, the photovoltaic device may include bus bars 207a and 207b which are in communication with the positive and negative electrodes of the device. The bus bars 207a and 207b may be disposed on a top, light incident surface of the photovoltaic device; however, it is to be understood that in some instances, bus bars or other current collecting structures may be otherwise disposed, or in some instances eliminated. All of such embodiments are within the scope of the present invention.

The photovoltaic building material of the present invention is characterized in that it is capable of generating photovoltaic power and while maintaining resistance to fire and flame spread. The present invention may be used in combination with a self-adhesive. By self-adhesive, it is meant that the material includes an adhesive which functions to retain it onto a building structure, without the need for other fasteners. Examples of self-adhesive designs applicable to the present invention are disclosed in U.S. Pat. No. 6,729,081 issued to Nath et al. on May 5, 2004 (hereinafter “081 Patent”), the disclosure of which is hereby incorporated herein by reference. To further provide resistance to fire and flame spread the photovoltaic building material of the present invention may include at least one firebreak as detailed in the '081 Patent.

### EXAMPLE 1

An example of the present invention was assembled by first laying 10 g/m² glass mat on top of a solar panel that had been hard coated with a recently cold plasma treatment on the bonding surface. Glass spheres (SPHERIGLASS® #2429) having a diameter of 80 μm were combed into the surface of the glass mat to 30 g/cm with an approximately even distribution. The glass spheres were preheated to above 100° C. for 5 minutes in vacuum>25 inches Hg and allowed to cool in inert gas before sorting into glass mat. The sealant was applied in a zigzag pattern so when TEFZEL®, with the cold plasma side facing the adhesive panel, is placed and squeezed under vacuum the air entrapped in the glass mat plus glass spheres is vented allowing bubble free penetration of the adhesive. This example demonstrates a photovoltaic module that includes an encapsulant layer that contains a polymer with glass particles dispersed therein. In one embodiment, the encapsulant polymer is a fluorine containing polymer and in another embodiment, the encapsulant polymer is a non-fluorine containing polymer.

### EXAMPLE 2

In this example, a series of photovoltaic modules was prepared having various combinations of top lamination layers. Each sample module included a substrate onto which a photovoltaic device similar to the triple cell device depicted in FIG. 1 was deposited. After deposition of the photovoltaic device was completed, one or more lamination layers was applied to the top surface of the photovoltaic device to provide encapsulation or coverage. The lamination layers included one or more of EVA (ethylenevinylacetate), GMC (a non-woven fiber glass mat that includes a dispersion of glass fibers in an acrylic binder), and ETFE (an ethylene-tetrafluoroethylene copolymer). The lamination layers were applied in various orders and various thicknesses to the top side of the photovoltaic device. The layers were generally in the form of thin solid films or sheets and were applied sequentially to the photovoltaic module. The module was then heated to complete the lamination to form test modules for this example.

While not wishing to be bound by theory, it is expected by the present inventors that the presence of GMC leads to improved cut resistance; the presence of EVA leads to improved cut resistance, but compromises flame retardation and other fire resistant properties; and the presence of ETFE leads to improved flame retardation and other fire resistant properties, but compromises cut resistance. The examples included herein demonstrate how high cut resistance and high fire resistance can be achieved.

The samples prepared and tested for this example are shown in Table 1 below. The samples are indexed by number. The combination of lamination layers for each sample is indicated. The layers in each lamination stack are listed beginning with the top-most layer and descending toward the top surface of the photovoltaic device. The top lamination layer is the layer exposed to the ambient. The remaining layers are interior lamination layers positioned between the top

TABLE I
Summary of Lamination Stacks along with Cut Resistance and Flame Spread Resistance

| | | Total | | |
|---|---|---|---|---|
| | | EVA | Cut | Flame |
| | | Thickness | Resistance | Spread |
| Sample | Top Lamination Stack | (mil) | (lb) | (Class) |
| 1 | 2 mil ETFE/8 mil EVA | 8 | 2.0 | A |
| 2 | 2 mil ETFE/GMC + 8 mil EVA | 8 | 2.0 | A |
| 3 | 2 mil ETFE/8 mil EVA + GMC | 8 | 2.0 | A |
| 4 | 2 mil ETFE/8 mil EVA/GMC/5 mil EVA | 13 | 3.5 | B |
| 5 | 2 mil ETFE/5 mil EVA/2 mil ETFE/8 mil EVA/GMC | 13 | 7.0 | |
| 6 | 2 mil ETFE/8 mil EVA/GMC/2 mil ETFE/5 mil EVA | 13 | 7.0 | A |
| 7 | 2 mil ETFE/8 mil EVA + GMC/2 mil ETFE/8 mil EVA | 16 | 9.0 | |
| 8 | 2 mil ETFE/8 mil EVA/ETFE/8 mil EVA + GMC | 16 | 5.5 | |
| 9 | 2 mil ETFE/8 mil EVA/2 mil ETFE/8 mil EVA | 16 | 6.0 | |
| 10 | 2 mil ETFE/GMC + 16 mil EVA | 16 | 6.5 | |
| 11 | 2 mil ETFE/18 mil EVA + GMC | 18 | 6.0 | B |
| 12 | 2 mil ETFE/18 mil EVA | 18 | 2.0 | B |
| 13 | 2 mil ETFE/26 mil EVA + GMC | 26 | 8.5 | C |
| 14 | 2 mil ETFE/26 mil EVA/2 mil ETFE/26 mil EVA + GMC | 54 | 8.5 | |
| 15 | 2 mil ETFE/26 mil EVA/2 mil ETFE/26 mil EVA | 54 | 8.5 | |

lamination layer and the top surface of the photovoltaic device. The top surface of the photovoltaic device is the surface furthest removed from the substrate and corresponds to the light incident side of the photovoltaic device. Thicknesses of the lamination layers are listed in units of mil, where a mil corresponds to 0.001 inch. In Sample 1, for example, the top lamination layer is a 2 mil thick ETFE layer, which is placed on top of an 8 mil thick layer of EVA, which is placed directly on the top surface of the photovoltaic device. The lamination stacks listed for the other samples are interpreted analogously. The thickness of the GMC layer is typically about 6 mil when it is present in a lamination stack. Several of the samples were designed to include a layer of ETFE interposed between two EVA layers.

Table 1 shows the results of cut resistance tests and flame spread tests for the samples. The flame spread tests were performed by applying a flame to the top surface of the lamination stack of the photovoltaic module and measuring the rate at which the flame spreads across the surface. Depending on the slope of the photovoltaic module, the temperature of the flame, and the distance that the flame spreads, the laminated module receives a Class A (most demanding), Class B, or Class C (least demanding) rating. Since flames spread more quickly on sloped roofs than on flat roofs, the more demanding Class A flame rating requires the module to keep the spread of flames below a threshold distance while pitched at a steeper slope (e.g. 3:12) than the less demanding Class B and Class C standards. Similarly, the slope required for a Class B rating is steeper than the slope required for a Class C rating.

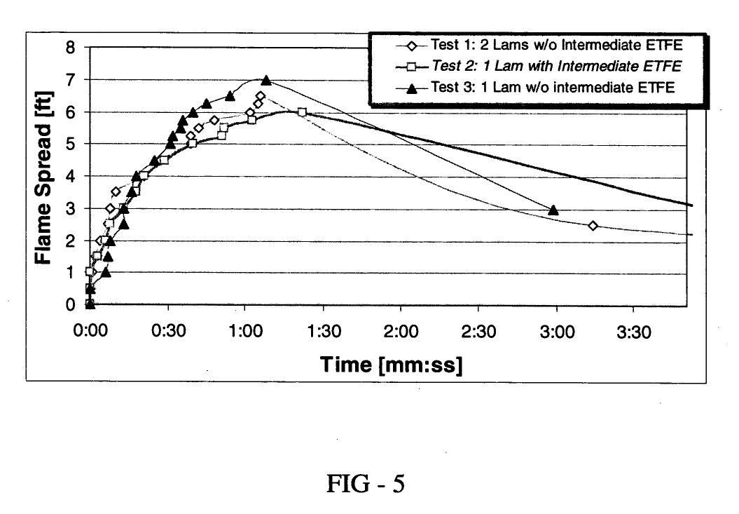

Representative flame spread test results are shown in FIG. 5. FIG. 5 shows the flame spread (measured in units of ft from the point of flame contact) as a function of time (measured in minutes and seconds). The curve labeled “Test 2” and depicted with square symbols is the test result for Sample 6, a sample that includes a layer of ETFE interposed between two layers of EVA. The curves labeled “Test 3” (depicted with triangle symbols) and “Test 1” (depicted with diamond symbols) show test results for Sample 4, a sample that lacks an interposed ETFE layer. The “Test 1” results correspond to a photovoltaic module having two lamination stacks of the type listed for Sample 4 in Table 1, while the “Test 3” results correspond to a photovoltaic module having one lamination stack of the type listed for Sample 4 in Table 1. Note that the total EVA thickness is the same for Sample 4 and Sample 6. A noteworthy feature of FIG. 5 is the reduction in flame spread that is observed for Sample 6 relative to Sample 4. Inclusion of the intermediate ETFE layer has markedly improved the flame spread characteristics of the photovoltaic module. Sample 6 received a Class A rating based on the test results, while Sample 4 garnered only a Class B rating.

The cut resistance test was performed by pressing a saw blade onto the surface of the top layer of the laminate stack, placing a weight on top of it, drawing the blade with the weight on it across the surface, and then performing accelerated testing of ultraviolet resistance and humidity tests. The weight listed for each sample in the “cut resistance” column of the table corresponds to a weight for which the sample passed the accelerated testing under conditions simulating 30 years of exposure to the ambient environment.

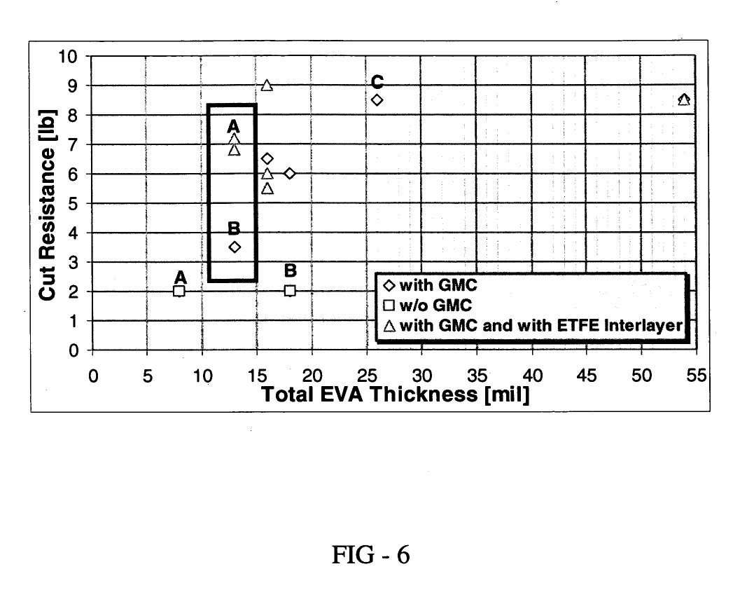

Representative cut resistance results are shown in FIG. 6 as a function of the total EVA thickness in the lamination stack. The points correspond to samples described in Table 1. Points designated with diamonds correspond to samples that include a layer of GMC, points designated with squares correspond to samples that lack a layer of GMC, and points designated with triangles correspond to samples that include a layer of GMC and an intermediate layer of ETFE. The flame spread Class rating is depicted for some of the points as well. The results generally show that the cut resistance does not improve for EVA thicknesses above 26 mil. The results also show that inclusion of the GMC layer generally improves the cut resistance. (See, for example, the improved cut resistance of Sample 11 relative to Sample 12 and the generally poorer cut resistance for the samples designated with squares.) The results also show that inclusion of an intermediate layer of ETFE generally improves both the cut-resistance and flame spread resistance. The results indicate that inclusion of ETFE or substitution of ETFE for a portion of the EVA enable modules that have improved flame spread ratings.

While the invention has been illustrated in detail in the drawings and the foregoing description, the same is to be considered as illustrative and not restrictive in character as the present invention and the concepts herein may be applied to any formable material. It will be apparent to those skilled in the art that variations and modifications of the present invention can be made without departing from the scope or spirit of the invention. For example, the present invention may be used with any encapsulant material or adhering layer. Thus, it is intended that the present invention cover all such modifications and variations of the invention that come within the scope of the appended claims and their equivalents.

We claim:

1. A photovoltaic module comprising:
a photovoltaic device; and
a laminate in physical contact with said photovoltaic device, said laminate comprising fluorine.

2. The photovoltaic module of claim 1, wherein said laminate comprises a fluoropolymer.

3. The photovoltaic module of claim 2, wherein said fluoropolymer comprises a copolymer of a fluorinated monomer and a non-fluorinated monomer.

4. The photovoltaic module of claim 3, wherein said fluoropolymer comprises a copolymer of ethylene and tetrafluoroethylene.

5. The photovoltaic module of claim 1, wherein said laminate comprises a plurality of layers, said plurality of layers comprising a first fluorine-containing layer and a first non-fluorine-containing layer.

6. The photovoltaic module of claim 5, wherein each of said plurality of layers is a polymer.

7. The photovoltaic module of claim 5, further comprising a second non-fluorine-containing layer, said first fluorine-containing layer being interposed between said first and second non-fluorine-containing layers.

8. The photovoltaic module of claim 5, wherein said first non-fluorine-containing layer comprises glass fiber mat.

9. The photovoltaic module of claim 1, wherein said photovoltaic device includes a layer of silicon.

10. The photovoltaic module of claim 9, wherein said silicon is amorphous silicon.

11. The photovoltaic module of claim 9, wherein said layer of silicon is p-type.

12. The photovoltaic module of claim 11, further comprising a layer of intrinsic silicon, said layer of intrinsic silicon being formed over said layer of p-type silicon.

13. The photovoltaic module of claim 12, further comprising a layer of n-type silicon, said layer of n-type silicon being formed over said layer of intrinsic silicon.

14. The photovoltaic module of claim 1, wherein said laminate encapsulates said photovoltaic module.

15. The photovoltaic module of claim 1, wherein said module achieves a Class A flame spread rating.

16. The photovoltaic module of claim 1, wherein said module has a cut resistance of at least 5 lb.

17. A photovoltaic module comprising:
a photovoltaic device; and
a laminate in physical contact with said photovoltaic device, said laminate comprising a polymer, said polymer including a dispersed solid phase.

18. The photovoltaic module of claim 17, wherein said polymer comprises fluorine.

19. The photovoltaic module of claim 17, wherein said polymer is selected from the group consisting of ethylenevinylacetate, silicon, urethane, sodium ionomer and zinc ionomer.

20. The photovoltaic module of claim 17, wherein said dispersed solid phase comprises glass fibers.

21. The photovoltaic module of claim 17, wherein said laminate comprises a plurality of layers, said plurality of layers comprising a fluorine-containing layer, and a non-fluorine-containing layer, said non-fluorine-containing layer comprising said polymer.

22. The photovoltaic module of claim 17, wherein said laminate further comprises glass fiber mat.

23. The photovoltaic module of claim 17, wherein said dispersed solid phase comprises glass spheres.

24. The photovoltaic module of claim 23, wherein said glass spheres have a diameter of about 80 μm to about 250 μm.

25. The photovoltaic module of claim 24, wherein said polymer comprises ethylenevinylacetate.

26. The photovoltaic module of claim 17, wherein said photovoltaic device includes a layer of silicon.

27. The photovoltaic module of claim 26, wherein said silicon is amorphous silicon.

28. The photovoltaic module of claim 26, wherein said layer of silicon is p-type.

29. The photovoltaic module of claim 28, further comprising a layer of intrinsic silicon, said layer of intrinsic silicon being formed over said layer of p-type silicon.

30. The photovoltaic module of claim 29, further comprising a layer of n-type silicon, said layer of n-type silicon being formed over said layer of intrinsic silicon.

31. The photovoltaic module of claim 17, wherein said laminate encapsulates said photovoltaic module.

32. The photovoltaic module of claim 17, wherein said module achieves a Class A flame spread rating.

33. The photovoltaic module of claim 17, wherein said module has a cut resistance of at least 5 lb.
